(19) United States
(12) Patent Application Publication
(10) Pub. No.: US 2012/0130887 A1
(43) Pub. Date: May 24, 2012

(54) POINT OF SALE SAVING SYSTEM

(76) Inventor: Graham Meckling, Victoria (CA)

(21) Appl. No.: 13/298,794

(22) Filed: Nov. 17, 2011

Related U.S. Application Data
(60) Provisional application No. 61/415,246, filed on Nov. 18, 2010.

(51) Int. Cl. G06Q 40/02

(52) U.S. Cl. 705/39

(57) ABSTRACT

An Internet-implemented computerized saving and investment system, that in use is integrated with a business's point of sale system, with which employees, for example employee who are compensated at least in part by tips from customers, may direct that funds be deposited to their credit in a savings/investment vehicle, for example a bank account.

### RELATED APPLICATION

This application claims the benefit of and priority to U.S. Provisional Application Ser. No. 61/415,246, filed Nov. 18, 2010, the content of which is incorporated by reference herein in its entirety.

### FIELD OF THE INVENTION

This invention relates to an Internet-implemented money management and saving system, and more particularly to such a system integrated with a point of sale system whereby a person can use components of the point of sale system to direct funds to a savings vehicle.

### BACKGROUND OF THE INVENTION

Point of sale systems (referred to herein at times as POS systems) are computerized systems incorporating registers, computers and peripheral equipment, usually on a computer network, and are used in recording customer transactions and, where appropriate, in calculating server tips.

POS systems are used to keep track of sales, labor and payroll, and to generate records used in accounting and bookkeeping. Typically, POS systems are configured such that corporate offices, troubleshooters and other authorized parties may access them, and obtain data from them, remotely, typically via the Internet using secure (e.g. encrypted) communications protocols.

In most current POS systems, cash registers are computers, sometimes with touch screens. POS systems have been widely adopted in the restaurant industry. In many restaurant implementations, the “cash register” is portable, such that a payment transaction may be conducted at a patron's table. Typically, the registers in a restaurant are connected (often, via wireless connection) to a computer server, often referred to as a “store controller” or a “central control unit” or “restaurant server/POS hub”. In many instances the data contained in the restaurant server/POS hub is accessible remotely and is often synced to an offsite server (generally referred to herein as a “POS server”), for example to enable a head office to monitor and record detail and summary data relating to transactions in multiple restaurants.

In some business areas, notably in the hospitality industry, and most notably in restaurants, workers, for example, restaurant servers, are at least in part compensated for their work by way of gratuities (commonly referred to as tips). In addition to the servers who directly served the tipping customers, other employees in the establishment who are not directly serving customers may also receive compensation based on tips collected by others. A tip pool is a longstanding practice for compensating different positions throughout a restaurant.

The customer payments are typically made in cash, by credit card, by debit card, or by a combination of these. The customer payments collected by such servers comprise both the payment to the business for a billed amount plus gratuities. At cash out, which typically occurs when a server is done his or her shift, the tips attributable to the server are calculated as difference between the amount the business charged the server's customers and the amount received from the server's customers. Typically, the server receives his or her tips (less any amount to be contributed to a tip pool), in cash at the conclusion of his or her shift.

Tips received in cash at the end of a shift may easily be squandered, especially by younger persons working late shifts, as banks and most other businesses are closed when they finish work, but bars and nightspots are often open, which are an enticement to spend the cash in hand.

Further, payments in the form of tips are often not well documented and may not be properly reported as income for tax purposes. Thus, the payment of tips in cash encourages tax evasion, which is illegal, and although it provides a short-term benefit to a server may have longer term adverse consequences beyond possible criminal sanctions in that a low reported income may adversely affect an individuals apparent credit worthiness.

### SUMMARY OF THE INVENTION

In one aspect, the present invention provides a system, preferably an Internet-implemented system, configured to be integrated with establishments' point of sale systems for the purpose of diverting money, that would otherwise be received in cash by employees, to saving and/or investment vehicles.

In another aspect, the present invention provides a saving system for use by a user, with a business's point of sale system for handling and recording sales transactions, and a savings vehicle, the saving system including: a subsystem component configured for integration with a point of sale system wherein when so integrated, the subsystem component enables a user to identify funds to be diverted to a savings vehicle and funds to be disbursed to the user; and produces data relating to such funds transactions; and a programmable computer or a plurality of interconnected programmable computers, configured to receive such user's funds transactions data from the point of sale system and to perform a reconcile function with respect to the funds transactions data and actual savings vehicle transactions; wherein the user may direct that funds of record in the point of sale system be diverted to a savings vehicle by the business and the programmable computer or a plurality of interconnected programmable computers determine whether such directions are implemented.

The point of sale system may include a point of sale terminal having a display screen and an aspect of the subsystem component displays on the screen such that the user may direct that funds be diverted to a savings vehicle using the point of sale terminal. The aspect of the subsystem component that displays on the screen may include a plurality of icons for a corresponding plurality of preset amounts to be diverted to a savings vehicle. The display screen may be a touch screen whereby a preset amount to be diverted to a savings vehicle may be selected by touching the corresponding icon.

The saving system may include an openable communication channel between the user and the programmable computer or plurality of interconnected programmable computers, wherein the user may review the status of the user's funds and request transfers or withdrawals of the funds. The openable communication channel may include the communications via the Internet. The openable communication channel may include a publicly accessible website having user log in procedures that impede unauthorized access to funds status information.

The programmable computer or plurality of interconnected programmable computers, may include an administration facility that evaluates each user withdrawal request, and either refuses the request, implements the request, or issues an alert and defers implementation of the request. The administration facility may implement a user withdrawal request by instructing the savings vehicle to transfer the requested funds to the user. The transfer of requested funds to the user may be by email funds transfer or by electronic account-to-account transfer.

The savings vehicle may be an account with a bank.

In another aspect the present invention provides a point of sale-saving system for performing point of sale functions and for enabling a user to direct funds to a savings vehicle, the system including: a point of sale terminal configured to permit a user to direct that funds associated with the user be diverted to a savings vehicle, and configured to handle and record sales transactions and said fund diversions; and a programmable computer or a plurality of interconnected programmable computers, directly or indirectly communicably connected to the point of sale terminal so as to obtain records of said fund diversions, and directly or indirectly communicably connected to the savings vehicle, and configured to perform a reconcile function with respect to the records of said fund diversion and actual savings vehicle transactions.

The point of sale terminal may have a display screen that may be caused to display a screen having a plurality of icons for a corresponding plurality of preset amounts to be diverted to a savings vehicle. The display screen may be a touch screen whereby a preset amount to be diverted to a savings vehicle may be selected by touching the corresponding icon.

The system may include an openable communication channel between the user and the programmable computer or plurality of interconnected programmable computers, wherein the user may review the status of the user's funds and request transfers or withdrawals of the funds. The saving system of claim 15, wherein the openable communication channel includes communications via the Internet and a publicly accessible website having user log in procedures that impede unauthorized access to funds status information.

The programmable computer or plurality of interconnected programmable computers, may include an administration facility that evaluates each user withdrawal request, and either refuses the request, implements the request, or issues an alert and defers implementation of the request. The administration facility may implement a user withdrawal request by instructing the savings vehicle to transfer the requested funds to the user. The transfer of requested funds to the user may be by email funds transfer or by electronic account-to-account transfer.

The savings vehicle may be an account with a bank.

### SUMMARY OF THE DRAWINGS

FIG. 1 is a schematic representation of an embodiment of the present invention in which an industry saving server communicates with a restaurant POS hub.

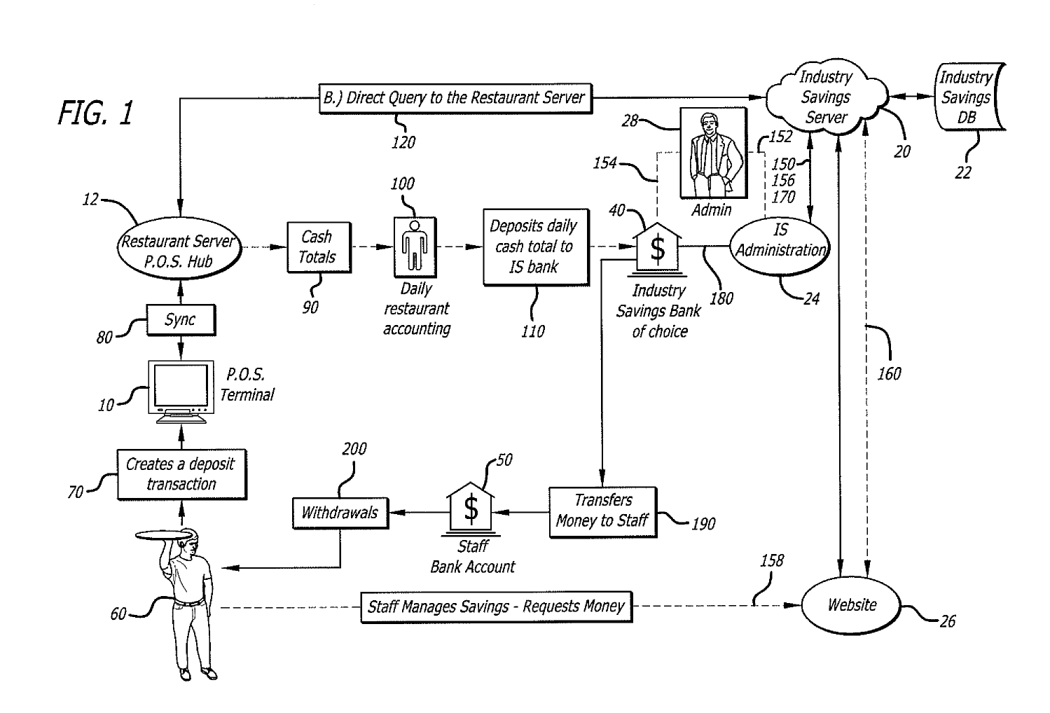

FIG. 2 is a schematic representation of an embodiment of the present invention in which an industry saving server communicates with a POS server which receives data from one or more restaurant POS hubs.

### DETAILED DESCRIPTION

Exemplary embodiments of the current invention are illustrated in the drawings.

In the specification and drawings, system embodiments of the present invention and components of same are at times identified using the terms “Industry Savings” and/or “I.S.”.

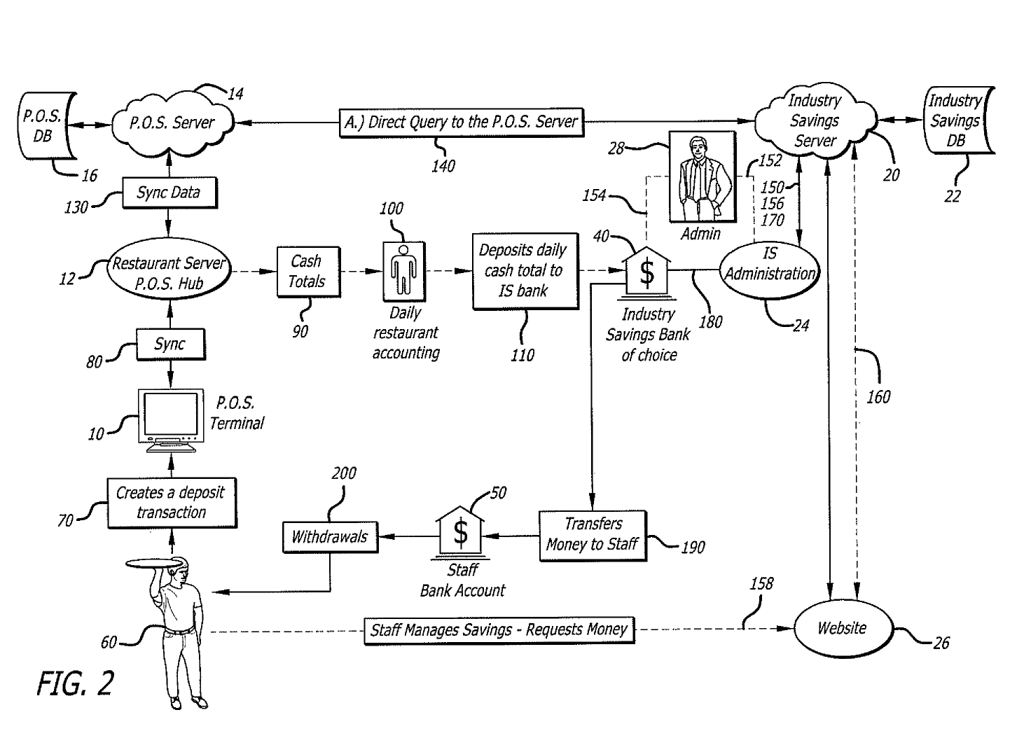

As shown in the drawings, known POS systems generally comprise, one or more POS terminals 10 connected to a restaurant server/POS hub 12. As indicated in FIG. 2, such restaurant server/POS hubs 12 are often connected to a remote POS server 14 (typically via the Internet). A POS server 14 will typically have an integral or associated data storage device, referred to herein as the POS database 16.

The connection between the POS terminal 10 and the restaurant server/POS hub 12 may be by cable or wireless. When in use, the communication between the POS terminal 10 and the restaurant server/POS hub 12 may be essentially continuous such that the POS terminal 10 is essentially a dumb terminal, that is, the POS terminal 10 merely displays data from and directs instructions to the restaurant server/POS hub 12. Alternatively, the POS terminal 10 may be configured to store and process data independently of the restaurant server/POS hub 12, and to intermittently sync data with the restaurant server/POS hub 12 (either reasonably frequently or less frequently, for example if the POS terminal 10 is a node in a distributive system of peer POS terminals 10 that are essentially “backed up” on a restaurant server/POS hub 12 or equivalent). In whatever way the POS terminal 10 may be configured, as one of the purposes of a POS system is to collect transaction information for accounting and bookkeeping purposes, transaction information collected by the POS terminal 10 will be received and collected by the restaurant server/POS hub 12 and possibly by a POS server 14.

As indicated in the drawings, a system embodiment of the present invention includes a programmable computer or a plurality of interconnected programmable computers, and an associated data storage device or associated data storage devices, connected to the Internet and configured to provide the following system components: I.S. Server 20; I.S. Database 22; I.S. Administration 24; and I.S. Website 26.

I.S. Server 20 is a computer/storage device/program configured for organizing and collecting all information from the IS database as well as from the I.S. administration.

I.S. Database 22 is a computer/storage device/program configured for storing information obtained from the restaurant server/POS hub 12 or the POS server 14.

I.S. Administration 24 is a computer/storage device/program configured to reconcile and monitor collected data and financial transactions. The monitoring of the financial transactions performed by the I.S. Administration 24, includes identifying the occurrence of specified action items (which specified action items may include unusual transactions that could indicate fraud or theft) and, in the event of the occurrence of an action item, notifying I.S. Admin personnel 28 of same and delaying any associated requested transaction pending review and approval by I.S. Admin personnel 28.

I.S. Website 26 is a website/web portal supported by the I.S. Server 20 having a home/login page accessible via the Internet. Individuals with I.S. accounts may login using a unique employee identity (for example, an assigned number), a password and perhaps a unique identification associated with the relevant business (for example, a restaurant number). Once a person has logged in to their I.S. account, the person may obtain information on the status of the their account and give instructions regarding their holdings, including for the transfer and/or withdrawal of funds.

Operation of the I.S. system involves an account or accounts in a financial institution, or accounts in multiple financial institutions, wherein each such financial institution is capable of modern electronic banking, including online/electronic fund transfers and payments, for example, email fund transfers (EFT's). In this description and the drawings, an exemplary account in a financial institution is identified as Industry Savings Bank of choice 40.

The I.S. system is implemented at a business that wishes to provide it to its employees, by: creating an I.S. account for the business; establishing a procedure or procedures for depositing funds to the Industry Savings Bank of choice 40; and integrating I.S. software with the business's POS system.

The procedures for depositing funds to the Industry Savings Bank of choice 40 may include: establishing the Industry Savings operator as a payee in the business's online banking system; establishing an account or procedure to enable the Industry Savings operator to directly debit funds from the account; transfer funds to the Industry Savings operator via email fund transfers; make direct deposits to an account designated by the Industry Savings operator; etc.

Integrating I.S. software with the business's POS system typically involves activation of an IS screen and it's functions through the business's POS software (for example, Micros™). This is typically simply a one-time download from the POS software provider or it can also be done in-house by manually adding the Industry Savings screen and its monetary buttons from the main POS computer (the same as if the business were were to add a “sandwich” screen and in that screen a B.L.T, clubhouse, etc. . . . )

For restaurant POS systems, the Industry Savings software is the equivalent of an update to the POS. software. The Industry Savings software preferably provides: An IS screen menu button; and a sub-screen, preferably including pre-fixed dollar amounts ($5, $10, etc.) to enable a server to allocate funds to the I.S. system as tips are received. The Industry Savings software records the amounts allocated to the I.S. system, enables the server to adjust the total prior to cash out; and identifies the amount allocated to the I.S. system as a portion of the “daily cash owed” (being, the amount retained by the business). Preferably, the integration of the I.S. system with the POS system is configured such that servers may obtain printed summaries of I.S. transactions along with the usual daily cash out report. Preferably, the integration of the I.S. system with the POS system is configured such that servers may also periodically obtain historical reports/summaries for transactions over defined periods of time.

A person who wishes to create an individual I.S. account may do so online on the I.S. website. The person creates the account by providing a user name and password, and information associated with a business that has implemented the I.S. system (or businesses that have implemented the I.S. system, in the case of an employee working for more than one such business). The person may also provide standing instruction with respect to the method by which the person wishes to receive funds from the Industry Savings Bank of choice 30. Alternatively, the person may provide such instructions on an ad hoc basis each time the person requests funds from the I.S. system. The method by which the person receives funds from the Industry Savings Bank of choice 30 may be email fund transfer. As another alternative, the person may designate a suitable recipient account to enable the person to receive funds from the Industry Savings Bank of choice 30. Presumably, this will be an account at a financial institution (e.g., a bank or credit union) capable of modern electronic banking. In this description and the drawings, an exemplary account at a financial institution is identified as Staff Bank Account 50.

Exemplary I.S. installations are illustrated in the drawings with respect to a restaurant business that has established an I.S. account and a waiter 60 employed by that business who has also established an I.S. account.

During a serving shift at the restaurant, the waiter 60 makes one or more allocations of funds to the I.S. system. This may be done with respect to particular patron transactions, for example through the following steps: waiter 60 logging on to POS terminal 10 using ID card or number into the POS system; waiter 60 choosing an open table on the POS system; waiter 60 selecting the IS icon or “button”; waiter 60 choosing a dollar amount; and waiter 60 closing the check with any form of payment. Alternatively, the waiter 60 may make a single allocation to the I.S. system, for example directly by the waiter 60 at cash out when the waiter 60 has determined the total tips received for the shift. Alternatively, a single allocation per shift may be made essentially automatically based on a rule previously established by the waiter 60 in the I.S. system. For example, the waiter 60 may have a preset amount for allocation to the I.S. system for each shift, or the waiter 60 may have a preset amount that the waiter 60 wishes to have in hand in cash at the end of each shift with the remaining balance allocated to the I.S. system. To be clear, the funds that the waiter 60 allocates to the I.S. system need not be derived from tips, the I.S. system enables the waiter 60 to allocate funds from any source and it is not eve necessary for the waiter 60 to be working when an allocation to the I.S. system is made. If the waiter 60 has extra cash from another source, the waiter could visit the restaurant, log in to the POS system and allocate the cash to the I.S. system and deliver the cash to the restaurant. In whatever way the allocation of funds to the I.S. system is implemented, the waiter 60 creates a deposit transaction 70 in a POS terminal 10.

The POS terminal 10 and the restaurant server/POS hub 12 sync 80, such that the restaurant server/POS hub 12 obtains sufficient information to prepare summary and detailed reports of deposit transactions, being cash totals and reports, that is, a report is generated daily from the restaurant POS that has the cash total as well as the individual totals.

The restaurant server/POS hub 12 provides the “cash total” report 90 to the daily restaurant accounting 100 (for example, the restaurant bookkeeper). The daily restaurant accounting 100 reviews and reconciles the amounts to be deposited to the Industry Savings Bank of choice 40; and deposits 110 daily cash totals to Industry Savings Bank of choice 40 (using one of the procedures described above).

The restaurant server/POS hub 12 reports the details of the deposit 10 to the I.S. Server 20, typically in response to a triggering hub query 120 from the I.S. Server 20 to the restaurant server/POS hub 12.

Alternatively, if, as is illustrated in FIG. 2, the restaurant server/POS hub 12 has synced data 130 to a POS server 14, POS server 14 may instead report the details of the deposit 10 to the I.S. Server 20, typically in response to a triggering POS server query 140 from the I.S. Server 20 to the POS server 14.

The I.S. Server 20 provides the POS data 150 to the I.S. Administration 24 to enable the I.S. Administration 24 to reconcile the transactions reported by the restaurant server/POS hub 12 or the POS server 14, as the case may be, with the actual transactions recorded by the Industry Savings Bank of choice 40. If the I.S. Administration 24 determines that the reported and actual transactions do not reconcile or if the I.S. Administration 24 detects a specified action item, the I.S. Administration 24 notifies 152 I.S. Admin personnel 28 of same to permit the I.S. Admin personnel 28 to review the transaction 154. Otherwise, the I.S. Administration 24 confirms the details of the transaction 156 to the I.S. Server 20.

The waiter 60 can track his savings & investment performance online at the I.S. Website 26. The funds that the waiter 60 allocates to the I.S. system may be held in a conventional bank account or, if the waiter 60 directs, may be invested in a mutual fund (or similar investment vehicle) operated by a host partner financial institution. Thus, the waiter will see his savings grow pay period after pay period; better money management habits with less wasteful spending; improved credit ratings; and opportunity for professional consultation on how to best manage his financial affairs through possible partner financial institutions. The waiter 60 may also be able to take part in exclusive benefits offered via the I.S. Website 26 such as: special offers to members from financial institutions and others; special discounts on frequently purchased items used by restaurant employees; access to exclusive employment page featuring job openings and special training opportunities; and special travel and vacation offers.

Keeping good employees loyal and productive has always been key to operating a successful restaurant. With the I.S. system, restaurant management has a tool to build employee loyalty by offering a valued service for no cost. By simply signing onto the I.S. system, employers can offer their employees an in-house savings system that is flexible, easy-to-install and requires very little support from the host employer. Tips can be tracked and directly deposited to the employee's account by the company. Restaurant employers will benefit from the I.S. system in the following ways: employees provided with a gratuity and payroll savings program that is easy to use; with a successful savings program at work, employees will be encouraged to stay longer, reducing costs and inconvenience of staff turnover; employers provided with a valued and easy way of rewarding performance and loyalty; and employers get added means of identifying top employees.

When the waiter 60 wishes to access the funds he has allocated to the I.S. system, waiter 60 logs on 158 to the I.S. Website 26 and makes a request to withdraw 160 the desired amount. The I.S. Server 20 processes this request and directs withdrawal request 170 to the I.S. Administration 24. The I.S. Administration 24 reviews the request, and either; refuses the request (for example, if the amount requested is greater than the amount being held to the credit of the waiter 60); or refers the request to I.S. Admin personnel 28 (for example, if the I.S. Administration 24 identifies the occurrence of a specified action item) and defers the transaction; or I.S. Administration 24 gives withdrawal implementation instructions 180 to the Industry Savings Bank of choice 40.

The withdrawal implementation instructions 180 given to the Industry Savings Bank of choice 40 are effected by way of a transfer 190 from the Industry Savings Bank of choice 40 to the Staff Bank Account 50 carried through in a manner pre-selected by the waiter 60, preferably electronically, for example via email fund transfer, by account-to-account transfer etc. The waiter 60 may of course withdraw funds 200 from Staff Bank Account 50 as the waiter wishes.

What is claimed is:

1. A saving system for use by a user, with a business's point of sale system for handling and recording sales transactions, and a savings vehicle, the saving system comprising:
a subsystem component configured for integration with a point of sale system wherein when so integrated, the subsystem component enables a user to identify funds to be diverted to a savings vehicle and funds to be disbursed to the user; and produces data relating to such funds transactions; and
a programmable computer or a plurality of interconnected programmable computers, configured to receive such user's funds transactions data from the point of sale system and to perform a reconcile function with respect to the funds transactions data and actual savings vehicle transactions;
wherein the user may direct that funds of record in the point of sale system be diverted to a savings vehicle by the business and the programmable computer or a plurality of interconnected programmable computers determine whether such directions are implemented.

2. The saving system of claim 1, wherein the point of sale system includes a point of sale terminal having a display screen and an aspect of the subsystem component displays on the screen such that the user may direct that funds be diverted to a savings vehicle using the point of sale terminal.

3. The saving system of claim 2, wherein the aspect of the subsystem component that displays on the screen includes a plurality of icons for a corresponding plurality of preset amounts to be diverted to a savings vehicle.

4. The saving system of claim 3, wherein the display screen is a touch screen whereby a preset amount to be diverted to a savings vehicle may be selected by touching the corresponding icon.

5. The saving system of claim 1, further comprising an openable communication channel between the user and the programmable computer or plurality of interconnected programmable computers, wherein the user may review the status of the user's funds and request transfers or withdrawals of the funds.

6. The saving system of claim 5, wherein the openable communication channel includes communications via the Internet.

7. The saving system of claim 5, wherein the openable communication channel includes a publicly accessible website having user log in procedures that impede unauthorized access to funds status information.

8. The saving system of claim 5, wherein the programmable computer or plurality of interconnected programmable computers, includes an administration facility that evaluates each user withdrawal request, and either refuses the request, implements the request, or issues an alert and defers implementation of the request.

9. The saving system of claim 7, wherein the administration facility implements a user withdrawal request by instructing the savings vehicle to transfer the requested funds to the user.

10. The saving system of claim 7, wherein the transfer of requested funds to the user is by email funds transfer or by electronic account-to-account transfer.

11. The saving system of claim 1, wherein the savings vehicle is an account with a bank.

12. A point of sale-saving system for performing point of sale functions and for enabling a user to direct funds to a savings vehicle, the system comprising:
a point of sale terminal configured to permit a user to direct that funds associated with the user be diverted to a savings vehicle, and configured to handle and record sales transactions and said fund diversions; and
a programmable computer or a plurality of interconnected programmable computers, directly or indirectly communicably connected to the point of sale terminal so as to obtain records of said fund diversions, and directly or indirectly communicably connected to the savings vehicle, and configured to perform a reconcile function with respect to the records of said fund diversion and actual savings vehicle transactions.

13. The system of claim 12, wherein the point of sale terminal has a display screen that may be caused to display a screen having a plurality of icons for a corresponding plurality of preset amounts to be diverted to a savings vehicle.

14. The system of claim 13, wherein the display screen is a touch screen whereby a preset amount to be diverted to a savings vehicle may be selected by touching the corresponding icon.

15. The system of claim 14, further comprising an openable communication channel between the user and the programmable computer or plurality of interconnected programmable computers, wherein the user may review the status of the user's funds and request transfers or withdrawals of the funds.

16. The system of claim 15, wherein the openable communication channel includes communications via the Internet and a publicly accessible website having user log in procedures that impede unauthorized access to funds status information.

17. The system of claim 15, wherein the programmable computer or plurality of interconnected programmable computers, includes an administration facility that evaluates each user withdrawal request, and either refuses the request, implements the request, or issues an alert and defers implementation of the request.

18. The system of claim 17, wherein the administration facility implements a user withdrawal request by instructing the savings vehicle to transfer the requested funds to the user.

19. The system of claim 18, wherein the transfer of requested funds to the user is by email funds transfer or by electronic account-to-account transfer.

20. The system of claim 12, wherein the savings vehicle is an account with a bank.
